(19) United States
(12) Patent Application Publication
(10) Pub. No.: US 2013/0085810 A1
(43) Pub. Date: Apr. 4, 2013

(54) FEDERATED BUSINESS CONFIGURATION AND SCOPING

(71) Applicants: Volker Driesen, Friedenstr. (DE); Peter Eberlein, Tulpenweg (DE)

(72) Inventors: Volker Driesen, Friedenstr. (DE); Peter Eberlein, Tulpenweg (DE)

(21) Appl. No.: 13/249,230

(22) Filed: Sep. 29, 2011

(51) Int. Cl. G06Q 10/06

(52) U.S. Cl. 705/7.37

(57) ABSTRACT

Methods and apparatus, including computer program products, are provided for scoping a software installation. Related apparatus, systems, methods, and articles are also described.

### FIELD

The present disclosure generally relates to installing software systems.

### BACKGROUND

Various organizations make use of enterprise resource planning (ERP) software architectures to provide an integrated, computer-based system for management of internal and external resources, such as for example tangible assets, financial resources, materials, customer relationships, and human resources. In general, an ERP software architecture is designed to facilitate the flow of information between business functions inside the boundaries of the organization and manage the connections to outside service providers, stakeholders, and the like. Such architectures often include one or more centralized databases accessible by a core software platform that consolidates business operations, including but not limited to those provided by third party vendors, into a uniform and organization-wide system environment. The core software platform can reside on a centralized server or alternatively be distributed across modular hardware and software units that provide “services” and communicate on a local area network or over a network, such as for example the Internet, a wide area network, a local area network, or the like.

As part of the installation process of the core software platform on computing hardware owned or operated by the organization, one or more customized features, configurations, business processes, or the like may be added to the default, preprogrammed features such that the core software platform is configured for maximum compatibility with the organization's business processes, data, and the like.

The core software platform of an ERP software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. Smaller organizations can also benefit from use of ERP functionality. However, such an organization may lack the necessary hardware resources, IT support, and/or consulting budget necessary to make use of a standalone ERP software architecture including on-premises components. As such, the organization can in some cases be more effectively served by an on-demand system or component, such as a software as a service (SaaS) arrangement in which the ERP system architecture is hosted on computing hardware such as servers and data repositories that are maintained remotely from the organization's location and accessed on-demand by authorized users at the organization via a thin client, such as for example a web browser, over a network.

### SUMMARY

In one aspect, there is provided a computer-implemented method. The method may include receiving a request to scope a configuration of a system including at least one on-premises component implementing a portion of a business process; determining the scope based on metadata describing the at least one on-premises component implementing the portion of the business process; determining another scope of at least one on-demand component being considered to replace the at least one on-premises component implementing the portion of the business process; determining, based on the results of the determining the scope and the determining the another scope, whether the at least one on-demand component being considered to replace the at least one on-premises component is suitable for use for the portion of the business process; generating a page indicating whether the at least one on-demand component being considered to replace the at least one on-premises component is suitable for use for the portion of the business process; and sending the page to a user interface.

In some implementations, one of more variations may be made as well as described in the detailed description below and/or as described in the following features. A configurator may receiving the request sent from a user interface. The configurator may access metadata describing the at least one on-premises component implementing the portion of the business process at the system. The metadata may described a function provided by the at least one on-premises component. The configurator may access metadata describing the at least one on-demand being considered to replace the at least one on-premises component implementing the portion of the business process. The metadata may describe a function provided by the at least one on-demand component.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1 depicts a block diagram of a system for configuring a business system;

FIG. 2 depicts a page presented at a user interface to enable configuring a business system;

FIG. 3 depicts a process for configuring a business system;

FIG. 4 is a diagram showing an example of a multi-tenant approach to providing customized software services to multiple organizations from a single architecture; and

FIG. 5 is a diagram showing storage of both core software package data objects and tenant-specific data objects for each of multiple tenants of a multi-tenant system.

Like labels are used to refer to same or similar items in the drawings.

### DETAILED DESCRIPTION

The subject matter described herein relates to the scoping and business configuration process for a system seeking to implement at least one on-demand component.

When an on-demand system implementation is targeted to a system implemented using an existing on-premises implementation, the usage of the existing on-premises system must be evaluated to determine the scope of the on-demand implementation. To introduce a new process using an on-demand approach requires an analysis to determine which aspects of a business process already run, or should be run, on-premise at the user's location and which aspects can be offered on-demand via the cloud. Moreover, the analysis may evaluate the orchestration between the on-demand components of the system providing the business process and the on-premise components.

To enable on-demand system components to be introduced into an existing business process having on-premise components, an on-demand solution may provide one or more options during installation to allow a user to opt out and select an on-premise component, rather than the on-demand component. As such, a user may select according to usage on-premises, which components should be implemented on-demand and which should remain on-premises.

To allow the above-noted selection between on-demand and on-premise components, the subject matter described herein provides information and/or tools to a user to enable a user to select which aspects of a business process are implemented on-demand and which are implemented on-premise. The selection is based on at least a stored business configuration for a user's business process and a scoping of the on-demand business offering. Moreover, the subject matter described herein may provide a user with one or more pages at a user interface to allow the user to visualize appropriate selections between on-demand components and on-premises components implementing a business process.

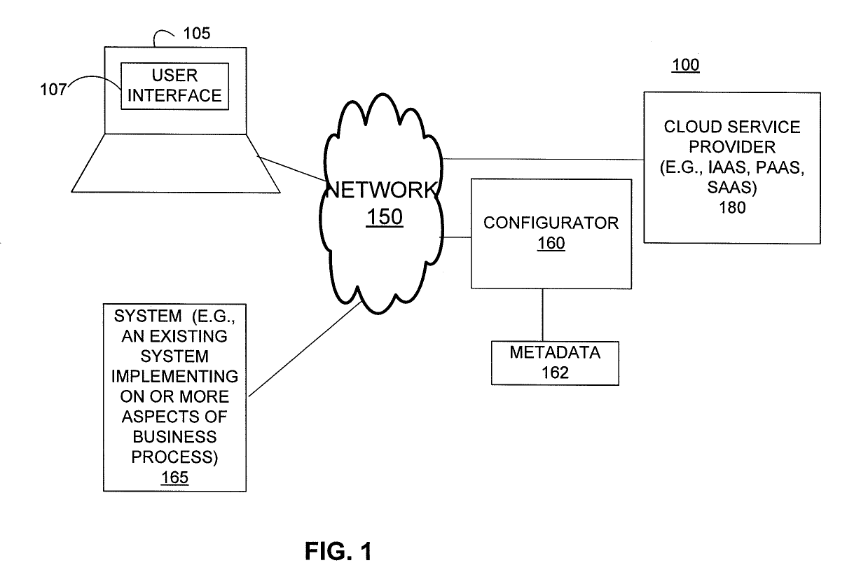

FIG. 1 depicts a system 100 including at least one computer 105, at least one existing system 165 implementing a portion of a business process on-premises of an entity, such as a user, a configurator 160 for scoping aspects of the business process, aspects of the existing on-premise components being used at system 165, aspects of on-demand components being used, and aspects of additional on-demand components considered to be implemented at system 165. The system 100 may also include metadata 162 describing the existing implementation at system 165 and the scope of the on-demand components being considered for implementation at system 165. The system may also include a cloud service provider 180 and a network 150, such as the Internet and the like, to couple aspects of system 100.

The computer 105 may further include a user interface 107. The user interface 107 may be implemented as any type of interface that enables interaction with aspects of system 100, including configurator 160. The user interface 107 may present one or more steps of a business process and allow an indication to be received selecting whether a step should be implemented using an on-demand component or on-premises component.

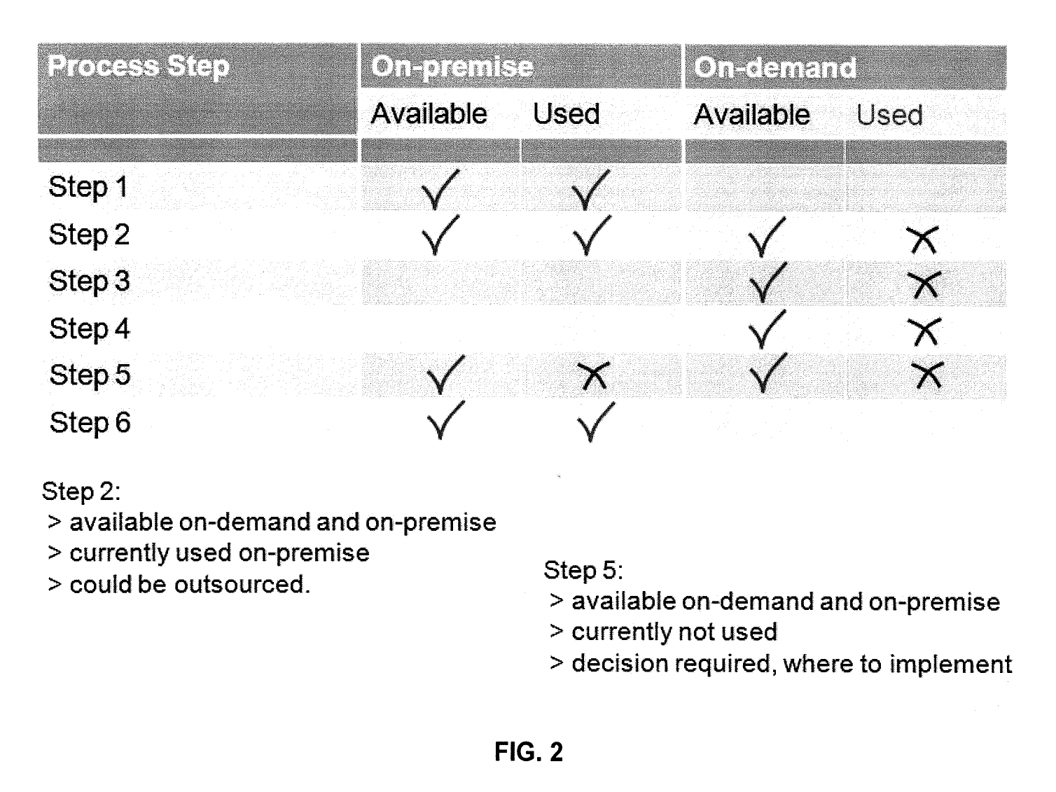

FIG. 2 depicts an example of a page presented at user interface 107 to allow such a selection to be made. Page 200 includes one or more steps of a business process and allows an indication to be made regarding whether a step should be implemented using an on-demand component or on-premises component. The page 200 may be generated by configurator 160 based on information provided by metadata 162, and then sent to user interface 107 for presentation. Referring to FIG. 2, the business process at system 165 may include six steps. According to the determination made by configurator 160 (based on metadata 162), on-premises components are available and being used to implement steps 1, 2, and 6 of the business process at system 165, and step 5 is not currently being used at system 165. According to the determination made by configurator 160 (and metadata 162), on-demand components can be used to perform steps 2, 3, 4, and 5 at system 100. Thus, a user may indicate that one or more steps 2, 3, 4, and 5 should be implemented using on-demand components (which may be made available via cloud service provider 180), rather than using on-premises components.

Referring again to FIG. 1, the system 165 may implement one or more business processes for an entity. The system 165 may include one or more on-premises components implementing some, if not all, of the business processes. Alternatively, system 165 may include one or more components implementing a portion of the components on-premises and a portion on-demand, i.e., implemented by, or available through, a cloud service provider, such as cloud service provider 180. Page 200 may be used to select whether on-premises or on-demand components should be used to implement the steps of the process at system 165.

The cloud service provider 180 may be implemented as a service, such as for example a web service. The cloud service provider 180 may be implemented as a web site or a portal that allows selection, configuration, purchase, hosting, execution, and/or use of cloud computing resources provided via the cloud service provider 180. For example, the cloud service provider 180 may be implemented as a cloud computing system at web site allowing a user to deploy software as a service, aspects of which may be selected by a user at user interface 107 via configurator 160.

The configurator 160 may scope the existing systems and processes being used based on metadata stored at 162. The configurator 160 may also provide information, such as page 200, to enable selection of whether a step of a process should be implemented on-premises or on-demand. For example, the configurator 160 may access metadata 162 (which describes the existing components at system 165 and describes the capabilities of on-demand components being considered for implementation at system 100) and determine, based on the metadata 162, whether a new step can be implemented using an on-premises component or an on-demand component. For steps already used, the system can determine, whether the step being used at system 165 could also be used at system 100.

In some implementations, the configurator 160 may compare the business functionality provided by on-premises components with on-demand components not yet installed at system 165 to identify the potential to install additional on-demand components. During this analysis, the configurator 160 may also identify whether a step (or function) used at on-premise system 165, could be replaced by an equivalent on-demand service at system 100, or whether the on-demand component cannot fully satisfy the needs. The configurator 160 may also determine on-premises components which have been modified and/or customized to a particular customer's application. The configurator 160 may then propose which on-demand components should be used by a user or a customer of system 165. In instances where an on-demand component fails to completely satisfy a portion of a process (e.g., a step) at system 165 (e.g., due to lack of functionality of the on-demand component and/or customizations to the on-premises component being considered for replacement), a user may still be given an option to use the on-demand component with an indication that the on-demand component needs to be extended to fully satisfy the requirements of the process.

In some implementations, the configurator 160 may process the metadata 162 to determine the scope of the configured on-premise components at system 165 implementing a business process, or processes, and to determine the scope of the functionality provided by on-demand components available at, or through, cloud service provider 180. This metadata is used by the configurator 160 to generate page 200.

Based on indications received from user interface 107 presenting, for example, page 200, the configurator 160 may then determine whether to implement the on-demand components for one or more steps of a business process and then initiate installation and implementation of the components in the cloud 180.

To illustrate by way of an example, configurator 160 may, in some implementations, analyze whether on-demand components or on-premises components are better suited for a given process step, determine whether master data storage is required for one or more steps of a process step, determine where any master data should be stored, determine any requirements for remote communications to support on-demand applications, determine whether the on-premise components satisfy the requirements for a business process step(s), and, if so, determine whether the on-demand coverage matches the requirements of the business process step. Based on this and the user's received indication, the configurator 160 generates a page 200 to enable selection, receives any selection(s), and then initiates the installation and implementation of the on-demand component.

In some implementations, when the scope of the functionality of the on-demand component nearly (or substantially) matches the requirements of the business process, the configurator 160 may generate a page and present the page at user interface 107 to allow, as noted above, a user to decide whether to select the on-demand component despite the failure to fully satisfy the functional requirements of the business process. The configurator 160 may also indicate (for example via page 200) whether the business process step should be modified (e.g., changed) in order to facilitate a match to an on-demand component being considered as a replacement for an on-premises component.

In some implementations, when the scope of the functionality of an existing on-premise component at system 165 has been modified (e.g., by a user) to satisfy a specific, unique process step at system 165, the configurator 160 may flag the step as one requiring an extension (or enhancement) to an on-demand component before the specific, unique process step can be fully implemented as an on-demand component via cloud service provider 180. The configurator 160 may thus identify where the scope of an on-demand component matches the functionality required to perform one or more steps at system 165; identify where the on-demand component matches the functionality fully; and identify where the on-demand component matches the functionality almost. For example, in this almost condition, the on-demand component may lack functionality to implement a step at system 165 or the on-premise component may have more functionality but a user of system 165 could still use the on-demand component, with using the function. If it matches “almost,” the scope difference may need to be further analyzed by the configurator 160 and additional information may need to be presented at user interface 107 to enable selection of an on-demand component and subsequent implementation of the on-demand component.

Once a customer decides to implement one or more on-demand components either to replace an existing on-premise component or to add a new step that had not yet been implemented at system 165, the configurator 160 may also assist in the installation and/or integration of the on-demand components. For example, the configurator 160 may assist with the replication processes for shared master data which are pre-configured with the right parameters to synchronize only the master data needed for the selected components for the process steps. The configurator 160 may also enable communication configuration for message exchange between on-premise and on-demand components implementing the business processes. For example, the communication configurations may be stored at metadata 162 as a pre-defined template for an on-demand component, in which case the configuration 162 may port (and/or adjust) the communications setting for use by the on-demand component. The configurator 160 may also handle triggers for cross-system process steps. This trigger information may also be stored at metadata 162 and then accessed for use by an on-demand component.

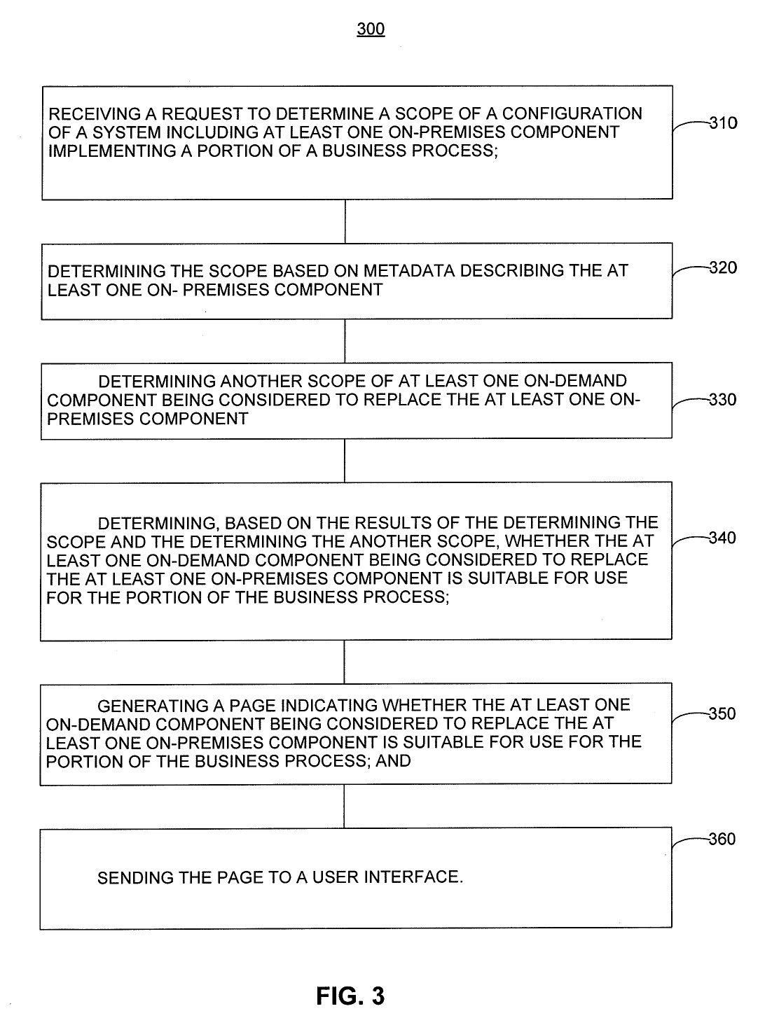

FIG. 3 depicts a process for scoping the configuration of an installation.

At 310, a request is received to scope the configuration of an existing system. For example, the configurator 160 may receive a request from user interface 107 to scope the configuration of system 165.

At 320, the scope of the configuration of system 165 may be determined. For example, configuration 165 may access metadata describing the business process being implemented at system 165. Moreover, the metadata 162 may include information describing the function provided by each step in the process and which components, such as on-premises components and on-demand components, at system 165 implement each step of the business process.

At 330, configurator 160 may also determine the scope of an on-demand component being considered for implementation to replace an on-premises component at system 165. For example, configurator 160 may access information at metadata 162 (or cloud service provider 180) describing the scope of the functionality provided by the on-demand component being considered for implementation to replace an on-premises component at system 165.

At 340, configurator 160 may determine whether the on-demand component being considered for implementation is suitable for use for a process step based on the determinations at 320 and 330. In instances where the on-demand component substantially matches the functional needs of a process step at system 165, the configurator 160 may indicate that the on-demand component is a potential match and provide additional information to enable a selection decision.

At 350, the configurator 160 generates a page for presentation at user interface. The page, such as page 200, provides information to enable a user to select between an on-demand component and an on-premises component.

At 360, the configurator 160 initiates an installation of on-demand components based on received information representative of the selections made at 350.

In some implementations, the cloud service provider 180 is implemented in accordance with multitenancy, so that the cloud service provider 180 can host multiple tenants (or entities, such as companies). The following provides a description of such implementations.

In a software delivery configuration in which services provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the cloud service provider 180 (which may be implemented as a software-as-a-service provider, SaaS) and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

Such an approach can introduce several challenges. Making modifications to the core software platform, for example updating to a new version, implementing a change to the core functionality, or the like, can become a complicated and unpredictable process if each tenant's customized data objects and other tenant-specific configurations do not react in the same manner to the modifications. Additionally, during a lifecycle management event, such as for example an upgrade or update, many application specific tasks may have to be executed in a multi-tenant system. One or more of these actions have to run on every business tenant that exists in the multi-tenant system. However, to start a task on a specific tenant, a user logon with password can be necessary, thereby requiring that the lifecycle management procedure have ready access to authentication information, such as for example user names and passwords, for each tenant. Such a requirement can create numerous disadvantages, including but not limited to security concerns, logistical difficulties pertaining to maintaining a current listing of authentication information for numerous tenants, and the like.

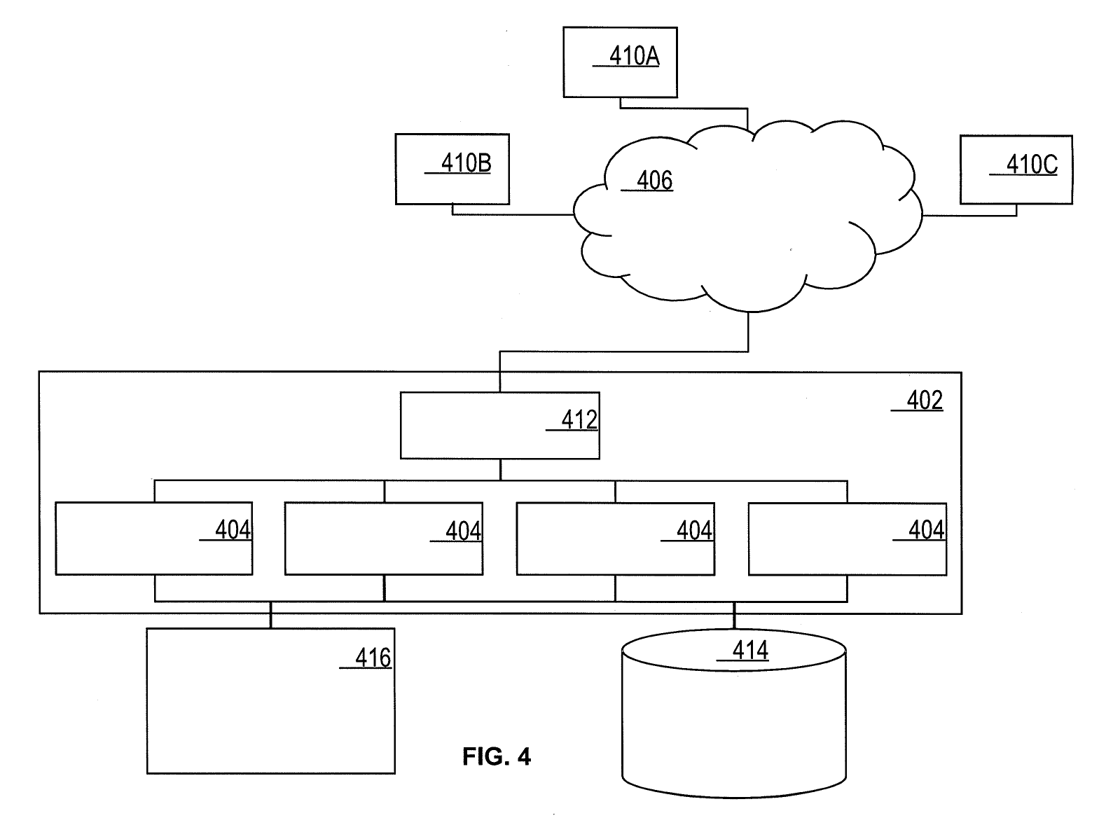

FIG. 4 shows a block diagram of a multi-tenant implementation of a software delivery architecture 400 that includes an application server 402, which can in some implementations include multiple server systems 404 that are accessible over a network 406 from client machines operated by users at each of multiple organizations 410A-410C (referred to herein as “tenants” of a multi-tenant system) supported by a single software delivery architecture 400. For a system in which the application server 402 includes multiple server systems 404, the application server can include a load balancer 412 to distribute requests and actions from users at the one or more organizations 410A-410C to the one or more server systems 404. A user can access the software delivery architecture across the network using a thin client, such as for example a web browser or the like, or other portal software running on a client machine. The application server 402 can access data and data objects stored in one or more data repositories 414. The application server 402 can also serve as a middleware component via which access is provided to one or more external software components 416 that can be provided by third party developers.

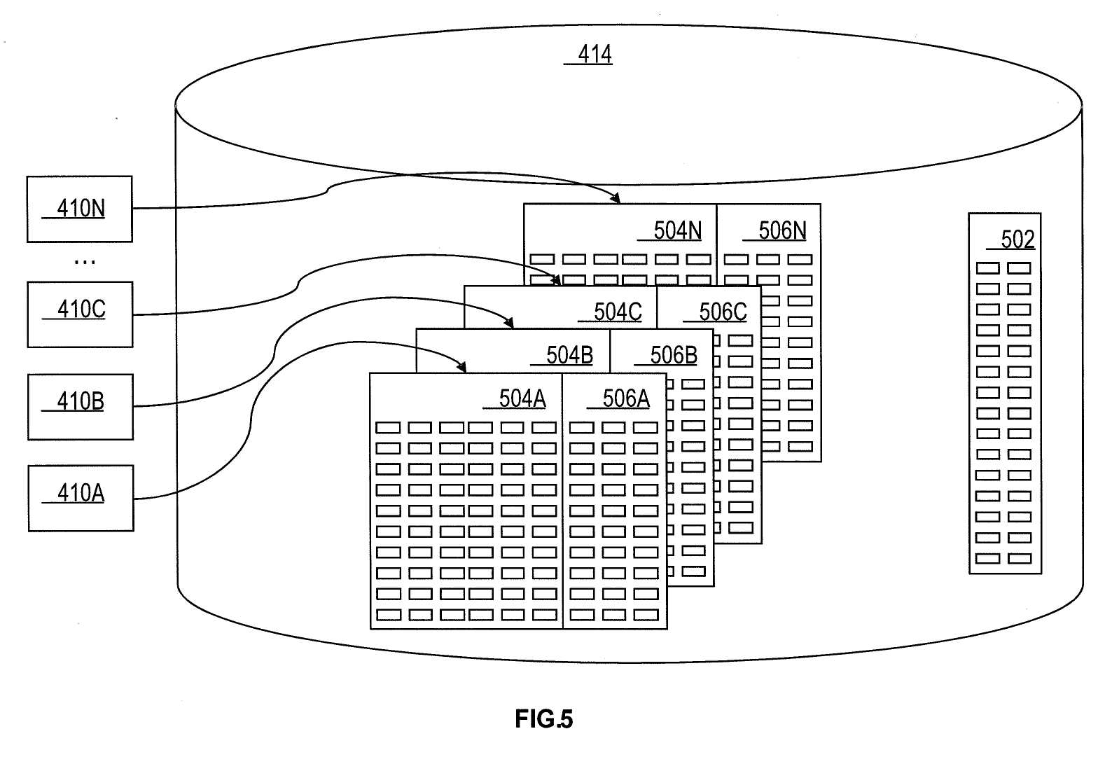

To provide for customization of the core software platform for each of multiple organizations supported by a single software delivery architecture 400 at cloud service provider 180, the data and data objects stored in the repository or repositories 414 that are accessed by the application server 402 can include three types of content as shown in FIG. 5: core software platform content 502, system content 504, and tenant content 506. Core software platform content 502 includes content that represents core functionality and is not modifiable by a tenant. System content 504 can in some examples be created by the runtime of the core software platform and can include core data objects that are modifiable with data provided by each tenant. For example, if the core software platform is an ERP system that includes inventory tracking functionality, the system content 504A-504N can include data objects for labeling and quantifying inventory. The data retained in these data objects are tenant-specific: for example, each tenant 410A-410N stores information about its own inventory. Tenant content 506A-506N includes data objects or extensions to other data objects that are customized for one specific tenant 410A-410N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 506 can include condition records in generated condition tables, access sequences, price calculation results, or any other tenant-specific values. A combination of the software platform content 502 and system content 504 and tenant content 506 of a specific tenant are presented to users from that tenant such that each tenant is provided access to a customized solution whose data are available only to users from that tenant.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants at cloud service provider 180 can be provided using an application server 402 that includes multiple server systems 404 that handle processing loads distributed by a load balancer 412. Potential benefits from such an arrangement can include, but are not limited to, high and reliably continuous application server availability and minimization of unplanned downtime, phased updating of the multiple server systems 404 to permit continuous availability (one server system 404 can be taken offline while the other systems continue to provide services via the load balancer 412), scalability via addition or removal of a server system 404 that is accessed via the load balancer 412, and de-coupled lifecycle processes (such as for example system maintenance, software upgrades, etc.) that enable updating of the core software independently of tenant-specific customizations implemented by individual tenants.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. The phrases “based on” and “based on at least” are used interchangeably herein as both phrases are equivalent. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

What is claimed:

1. A computer-readable medium containing instructions to configure a processor to perform operations comprising:
receiving a request to scope a configuration of a system including at least one on-premises component implementing a portion of a business process;
determining the scope based on metadata describing the at least one on-premises component implementing the portion of the business process;
determining another scope of at least one on-demand component being considered to replace the at least one on-premises component implementing the portion of the business process;
determining, based on the results of the determining the scope and the determining the another scope, whether the at least one on-demand component being considered to replace the at least one on-premises component is suitable for use for the portion of the business process;
generating a page indicating whether the at least one on-demand component being considered to replace the at least one on-premises component is suitable for use for the portion of the business process; and
sending the page to a user interface.

2. The computer-readable medium of claim 1, wherein the receiving further comprises:
receiving, at a configurator, the request sent from a user interface.

3. The computer-readable medium of claim 1, wherein the determining the scope further comprises:
accessing, by a configurator, metadata describing the at least one on-premises component implementing the portion of the business process at the system.

4. The computer-readable medium of claim 3, wherein the metadata describes a function provided by the at least one on-premises component.

5. The computer-readable medium of claim 1, wherein the determining another scope further comprises:
accessing, by a configurator, metadata describing the at least one on-demand being considered to replace the at least one on-premises component implementing the portion of the business process.

6. The computer-readable medium of claim 5, wherein the metadata describes a function provided by the at least one on-demand component.

7. The computer-readable medium of claim 1 further comprising:
implementing, in the business process, the at least one on-demand component based on a selection presented at the generated page.

8. A method comprising:
receiving, at a configurator, a request to scope a configuration of a system including at least one on-premises component implementing a portion of a business process;
determining, at the configurator, the scope based on metadata describing the at least one on-premises component implementing the portion of the business process;
determining, at the configurator, another scope of at least one on-demand component being considered to replace the at least one on-premises component implementing the portion of the business process;
determining, at the configurator, whether the at least one on-demand component being considered to replace the at least one on-premises component is suitable for use for the portion of the business process based on the results of the determining the scope and the determining the another scope;
generating, at the configurator, a page indicating whether the at least one on-demand component being considered to replace the at least one on-premises component is suitable for use for the portion of the business process; and
sending, by the configurator, the page to a user interface.

9. The method of claim 8, wherein the receiving further comprises:
receiving, at a configurator, the request sent from a user interface.

10. The method of claim 8, wherein the determining the scope further comprises:
accessing, by a configurator, metadata describing the at least one on-premises component implementing the portion of the business process at the system.

11. The method of claim 10, wherein the metadata describes a function provided by the at least one on-premises component.

12. The method of claim 8, wherein the determining another scope further comprises:
accessing, by a configurator, metadata describing the at least one on-demand being considered to replace the at least one on-premises component implementing the portion of the business process.

13. The method of claim 12, wherein the metadata describes a function provided by the at least one on-demand component.

14. A system comprising:
at least one processor; and
at least one memory configured to provide operations comprising:
receiving a request to scope a configuration of a system including at least one on-premises component implementing a portion of a business process;
determining the scope based on metadata describing the at least one on-premises component implementing the portion of the business process;
determining another scope of at least one on-demand component being considered to replace the at least one on-premises component implementing the portion of the business process;
determining, based on the results of the determining the scope and the determining the another scope, whether the at least one on-demand component being considered to replace the at least one on-premises component is suitable for use for the portion of the business process;
generating a page indicating whether the at least one on-demand component being considered to replace the at least one on-premises component is suitable for use for the portion of the business process; and
sending the page to a user interface.

15. The system of claim 14, wherein the receiving further comprises:
receiving, at a configurator, the request sent from a user interface.

16. The system of claim 14, wherein the determining the scope further comprises:
accessing, by a configurator, metadata describing the at least one on-premises component implementing the portion of the business process at the system.

17. The system of claim 16, wherein the metadata describes a function provided by the at least one on-premises component.

18. The system of claim 14, wherein the determining another scope further comprises:
accessing, by a configurator, metadata describing the at least one on-demand being considered to replace the at least one on-premises component implementing the portion of the business process.

19. The system of claim 18, wherein the metadata describes a function provided by the at least one on-demand component.
